(19) United States
(12) Patent Application Publication
(10) Pub. No.: US 2009/0169796 A1
(43) Pub. Date: Jul. 2, 2009

(54) Large laminated structure

(75) Inventor: Cheng-Chung Chang, Taipei County (TW)

Correspondence Address: BACON & THOMAS, PLLC, 625 SLATERS LANE, FOURTH FLOOR, ALEXANDRIA, VA, 22314-1176, US

(73) Assignee: SERCOMM CORPORATION, Taipei city (TW)

(21) Appl. No.: 12/003,411

(22) Filed: Dec. 26, 2007

(51) Int. Cl. B32B 9/00

(52) U.S. Cl. 428/42.1

(57) ABSTRACT

A large laminated structure includes a surface material, an ink layer, an adhesive layer and a release paper layer. The surface material has a bottom surface. The ink layer is disposed on the bottom surface in a predetermined pattern. The adhesive layer has a first planar surface and a second planar surface corresponding to each other. The adhesive layer has a plurality of channels connecting the first planar surface and the second planar surface. The first planar surface leans against and covers the bottom surface and the ink layer. The release paper layer is connected with the second planar surface. When the adhesive layer is attached to an attaching member, the gas between the adhesive layer and the attaching member may enter the channels of the adhesive layer such that the gas will not be trapped between the adhesive layer and the attaching member, thereby increasing the beauty of the attaching structure. In addition, the ink layer is disposed between the surface material and the adhesive layer to prevent the ink layer from wear, thereby maintaining integrity of the ink layer.

### BACKGROUND OF THE INVENTION

1. Field of the Invention

The present invention relates to a large laminated structure, and more particularly, to a technique that uses channels to disperse gas.

2. Description of Related Art

FIG. 1 illustrates a conventional laminated structure. In this figure, the laminated structure includes at least one release layer 11, an adhesive layer 12 and a trademark surface material 13. The release layer 11 has a smooth surface. The adhesive layer 12 is coated on one surface of the release layer 11, and has continuous grooves 121 formed in a surface of the adhesive layer 12 that faces to the release layer 11. A surface of the trademark surface material 13 has a pattern and character printing layer 131 formed thereon. Another surface of the trademark surface material 13 having no printing layer 131 is adhered to the surface of the adhesive layer 12.

During attachment, the laminated structure may not remain air bubbles. However, the groove 121 does not extend to connect two surfaces of the adhesive layer 12. As a result, during attachment, the groove 121 can only accommodate a limited amount of gas. If lamination of a large area or curve surface is desired, more grooves 121 are required to accommodate the increased amount of gas. In consequence, this will decrease the size and adhesive force of the adhesive layer. In addition, the printing layer 131 formed on the trademark surface material 13 may be damaged due to wear.

To overcome the above problems that do not remain gas bubbles and reduce the adhesive force either when a laminated structure is attached under the lamination of large area or curve surface so as to satisfy the demands of protecting the printing patterns, the inventor provides a large laminated structure after diligently research and development.

### SUMMARY OF THE INVENTION

Accordingly, the present invention is directed to a large laminated structure. In particular, the adhesive layer has channels that are in connect with two surfaces, such that gas can be dispersed through the channels without causing the gas to be trapped while attaching the adhesive layer.

Therefore, an embodiment of the present invention provides a large laminated structure including a surface material, an ink layer, an adhesive layer and a release paper layer. The surface material is made of a plastic material, and has a bottom surface. The ink layer is disposed on the bottom surface with a predetermined pattern. The adhesive layer has a first planar surface and a second planar surface corresponding to each other. The adhesive layer has a plurality of channels connecting the first planar surface and the second planar surface. The first planar surface abuts and covers the bottom surface and the ink layer. The release paper layer is connected with the second planar surface.

As describe above, in the large laminated structure of the present invention, when the adhesive layer is attached to an attaching member, the gas between the adhesive layer and the attaching member may enter the channels. Since the grooves of connecting the side of the adhesive layer is formed by the interlacing of the channels, gas can be dispersed through the grooves without remaining gas bubbles. In addition, since the channels connect the first planar surface and the second planar surface, more gas can be accommodated in the channels, such that the gas will likewise not be trapped for the lamination of large area or curve surface. Moreover, the ink layer is disposed between the surface material and the adhesive layer, and can thus be prevented from wear.

In order to make the aforementioned and other features and advantages of the present invention more comprehensible, embodiments accompanied with figures are described in detail below.

### BRIEF DESCRIPTION OF THE DRAWINGS

FIG. 1 illustrates a conventional attaching structure.

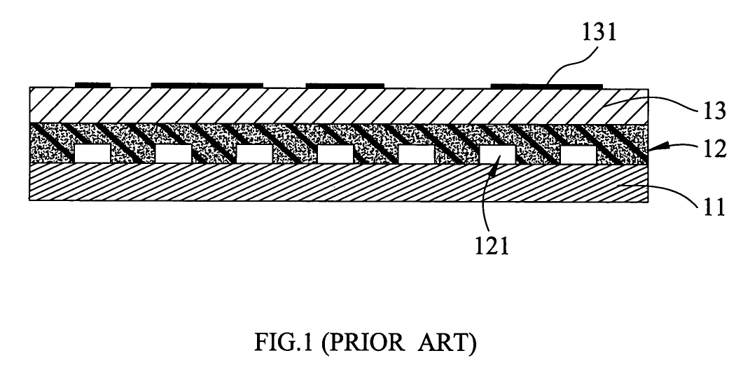

FIG. 2 is a cross-sectional view illustrating a large laminated structure of the present invention.

FIG. 3 is a cross-sectional view illustrating attachment of the large laminated structure of the present invention.

FIG. 4 is a schematic view illustrating dispersing gas in the laminated structure of the present invention.

### DESCRIPTION OF THE EMBODIMENTS

Hereinafter, a preferred embodiment of the present invention will be described in detail with reference to the accompanying drawings. The following embodiment is provided only for illustrative purposes to fully convey the scope of the present invention to those skilled in the art. Therefore, the present invention is not limited to the embodiment set forth herein but can be implemented in different forms. Like reference numerals indicate like elements throughout the specification.

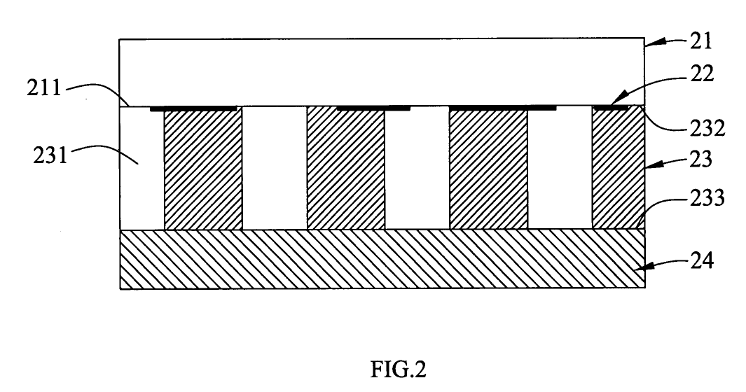

FIG. 2 is a cross-sectional view illustrating a large laminated structure of the present invention. In this figure, the large laminated structure includes at least a surface material 21, an ink layer 22, an adhesive layer 23 and a release paper layer 24. The surface material 21 is made of a plastic material, and has a bottom surface 211. The ink layer 22 is formed on the bottom surface 211 in a predetermined pattern. The adhesive layer 23 has a first planar surface 232 and a second planar surface 233 corresponding to each other. A plurality of channels 231 are formed in the adhesive layer 23 to connect the first planar surface 232 and the second planar surface 233. The first planar surface 232 leans against and covers the bottom surface 211 and the ink layer 22. The channels 231 are interlaced to form grooves (not shown) that connect the side of the adhesive layer. The release paper layer 24 is connected to the second planar surface 233 of the adhesive layer 23. The ink layer 22 is disposed between the surface material 21 and the adhesive layer 23, and is thus prevented from wear.

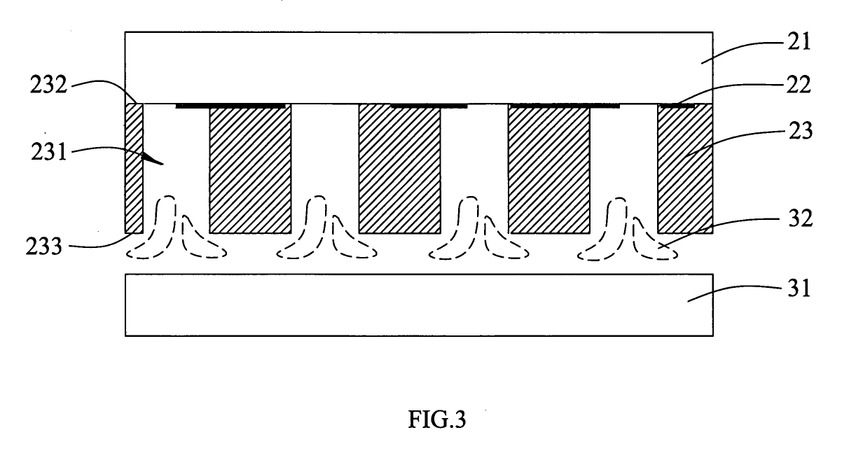

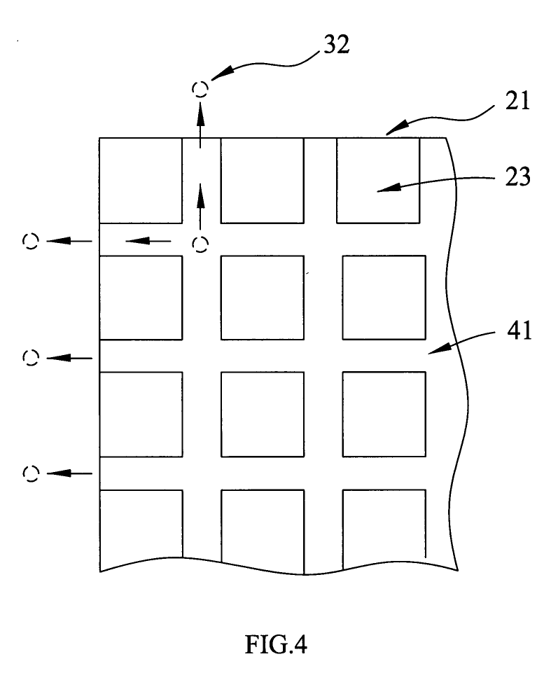

FIG. 3 is a cross-sectional view illustrating the attaching of the large laminated structure of the present invention, and FIG. 4 is a schematic view illustrating gas dispersed from the attaching structure of the present invention. In FIG. 3, when the large laminated structure is used, the release paper layer and the adhesive layer 23 are firstly separated. The second planar surface 233 of the adhesive layer 23 is adhered to an attaching member 31. At this time, the gas 32 between the adhesive layer 23 and the attaching member 31 is pressed to enter the channels 231. Because the channels 231 are interlaced to form the grooves 41 of connecting the side of the adhesive layer as shown in FIG. 4, the gas 32 entering the channels 231 will disperse into the external environment through the grooves formed by the interlaced structure of channels, such that the gas will not be trapped between the adhesive layer 23 and the attaching member 31.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A large laminated structure, comprising:
a surface material having a bottom surface;
an ink layer disposed on the bottom surface in a predetermined pattern;
an adhesive layer having a first planar surface and a second planar surface corresponding to each other, the adhesive layer having a plurality of channels connecting the first planar surface and the second planar surface, the first planar surface leaning against and covering the bottom surface and the ink layer; and
a release paper layer connected with the second planar surface.

2. The large laminated structure in accordance with claim 1, wherein the surface material is made of a plastic material.

3. The large laminated structure in accordance with claim 1, wherein the channels are interlaced to form an interlaced structure.

4. The large laminated structure in accordance with claim 3, wherein the interlaced structure is formed at least one groove.

5. The large laminated structure in accordance with claim 4, wherein the groove is connected the side surface that is opposite to the adhesive layer.

6. A large laminated structure, comprising:
a surface material having a bottom surface;
an ink layer disposed on the bottom surface in a predetermined pattern;
an adhesive layer having a first planar surface and a second planar surface corresponding to each other, the adhesive layer having a plurality of channels connecting the first planar surface and the second planar surface, the first planar surface leaning against and covering the bottom surface and the ink layer;
wherein when the adhesive layer is attached to an attaching member, gas between the adhesive layer and the attaching member enters the channels.

7. The large area attaching structure in accordance with claim 6, wherein the surface material is made of a plastic material.

8. The large area attaching structure in accordance with claim 6, wherein the channels are interlaced to form the interlaced structure.

9. The large area attaching structure in accordance with claim 8, wherein the interlaced structure is formed at least one groove.

10. The large area attaching structure in accordance with claim 9, wherein the groove is connected to the side that is opposite to the adhesive layer.
